(19) United States
(12) Patent Application Publication
(10) Pub. No.: US 2015/0317564 A1
(43) Pub. Date: Nov. 5, 2015

(54) TRAIT-BASED EARLY DETECTION OF INFLUENCERS ON SOCIAL MEDIA

(71) Applicant: International Business Machines Corporation, Armonk, NY (US)

(72) Inventors: Jilin Chen, Sunnyvale, CA (US); Jalal U. Mahmud, San Jose, CA (US)

(73) Assignee: International Business Machines Corporation, Armonk, NY (US)

(21) Appl. No.: 14/269,228

(22) Filed: May 5, 2014

(51) Int. Cl. G06N 5/04; G06Q 30/02; G06Q 50/00

(52) U.S. Cl. CPC G06N 5/04; G06Q 50/01; G06Q 30/0204

(57) ABSTRACT

A method and system for early detection of social media influencers which can use a communications system. A current influencer is selected from a plurality of users communicating on a social network, wherein the current influencer is based on a selection criteria. A database is generated from data of each of the users and the database includes traits of the current influencer. A predictive model is generated using the database. The predictive model includes a scoring method which includes comparing the traits of the current influencer with traits of the plurality of users gathered from the data. The data is analyzed to predict a future influencer of the plurality of users using the predictive model. A predicted future influencer is selected from the plurality of users, using the analysis.

### STATEMENT REGARDING FEDERALLY SPONSORED RESEARCH OF DEVELOPMENT

This invention was made with Government support under Contract No.: W911NF-12-C-0028 awarded by Army Research Office (ARO). The Government has certain rights in the invention.

### BACKGROUND

The present disclosure relates to a method and system for detecting social media influencers of a group on a communications network using a social media. Known social media accessed through a communications network can include a social website, or messaging service where groups of users can exchange and view information. The social information and data can be studied to determine trends, trend setters and influencers.

Methods of identifying an influencer in a social group may be based on, for example, a social media users' activity within the group, their topic-specific activity, an evaluation of their strength in the social network, their frequency and strength in reposting on the social network, etc. Such techniques employ analyzing past data from the users of the social network. A limitation of these approaches to identify influencer in the social group can be due to reliance on observable activity and social network based metrics of identified influencers, which are identified as a result of past activity.

### SUMMARY

It would be desirable to detect future influencers in a social group communicating via a social network. Identifying a future influencer can be useful to, for example, send targeted material to the identified future influencer. Therefore, it would be desirable to detect influencers in an electronic social group in an earlier phase of activity, rather than after such a label has been established by analysis techniques of past activity.

According to an aspect of the invention, a method of early detection of social media influencers can use a communications system. A current influencer is selected from a plurality of users communicating on a social network, wherein the current influencer is based on a selection criteria. A database is generated from data of each of the users and the database includes traits of the current influencer. A predictive model is generated using the database. The predictive model includes a scoring method which includes comparing the traits of the current influencer with traits of the plurality of users gathered from the data. The data is analyzed to predict a future influencer of the plurality of users using the predictive model. A predicted future influencer is selected from the plurality of users, using the analysis.

In another aspect of the invention, a computer program product includes a computer readable storage medium having program code embodied therewith, and the program code is executable by a processor to: selecting a current influencer from a plurality of users communicating on a social network, the current influencer being based on a selection criteria; generating a database from data of each of the users, the database including traits of the current influencer; generating a predictive model using the database, the predictive model including a scoring method which includes comparing the traits of the current influencer with traits of the plurality of users gathered from the data; analyzing the data to predict a future influencer of the plurality of users using the predictive model; and selecting a predicted future influencer from the plurality of users, using the analysis.

In another aspect of the invention, a system includes: a memory having computer readable computer instructions; and a processor for executing the computer readable instructions, the instruction including: selecting a current influencer from a plurality of users communicating on a social network, the current influencer being based on a selection criteria; generating a database from data of each of the users, the database including traits of the current influencer; generating a predictive model using the database, the predictive model including a scoring method which includes comparing the traits of the current influencer with traits of the plurality of users gathered from the data; analyzing the data to predict a future influencer of the plurality of users using the predictive model; and selecting a predicted future influencer from the plurality of users, using the analysis.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic block diagram illustrating an overview of a system and methodology for early detection of social media influencers using a communications network according to an embodiment of the disclosure;

FIG. 2 is a flow chart illustrating a method for detecting social media influencers according to an embodiment of the disclosure;

FIG. 3 is a functional block diagram illustrating a embodiment according to the present disclosure based on FIGS. 1 and 2;

FIG. 4 is a detailed block diagram of the program modules shown in FIG. 1; and

FIG. 5 is a chart of exemplary human values.

### DETAILED DESCRIPTION

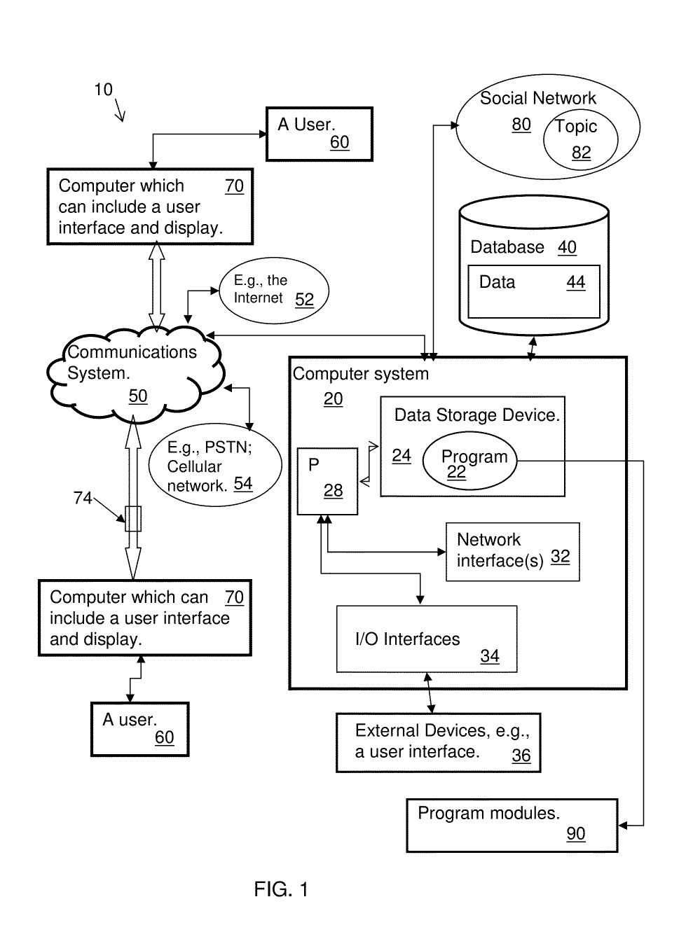

Referring to FIGS. 1-3, in one embodiment according to the present disclosure, a system 10 and method 100 for early detection of social media influencers uses a communications network. The method includes gathering data, using a computer, from a plurality of users communicating on a social network of a communications network. The users 60 shown in FIG. 1 are representative of a plurality of users which may include, for example, several users or dozens or even hundreds of users. Each of the users 60 have access to a communication device, which can be embodied as a computer 70, for example, a mobile device. For example, communications devices can include: a computer, or Personal Data Assistant (PDA), notebook, a tablet, a cell phone, or other mobile device, a laptop, a netbook, or a car communication system. The multiple users 60 computers 70 can communicate with a communications system 50. The computers 70 can send an electronic message, such as a text or an email. An electronic message is generically represented at message 74 in FIG. 1, which may include a text message, or an email message, or a message thread between multiple users or data, such as a message, photo, or text uploaded to a social media website.

Electronic messages can use the communications system 50, which can include, the Internet 52, or a public switched telephone network (PSTN) for example, a cellular network 54. The PSTN may include telephone lines, fiber optic cables, microwave transmission links, cellular networks, and communications satellites. Exemplary messaging services may include Short Message Service (SMS) which is a text messaging service component of phone, web, or mobile communication systems, using standardized communications protocols which allows the exchange of short text messages between fixed line or mobile phone devices. The Internet may facilitate numerous communications, such as email, and texting techniques, for example, using a cell phone or laptop computer to send text messages via Multimedia Messaging Service (MMS) (related to SMS) as one technique to send messages that include multimedia content to and from mobile phones, or to and from one or more email accounts via the Internet.

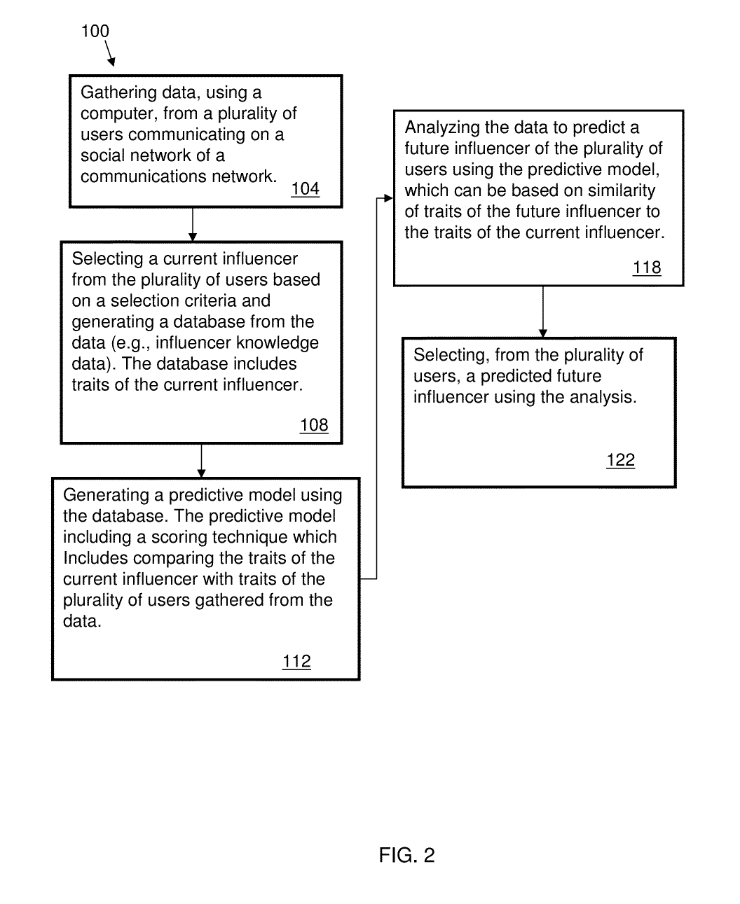

The method 100 includes gathering data, generically represented as data 44 stored in a database 40, using the computer 20, from the plurality of users 60 who are communicating, for example, on a social network 80 communicating with the communications system 50, as in block or step 104 of FIG. 2. The social network 80 can be accessible using the internet from the computers 70. The users 60 may be communicating regarding one or more topics or subject, etc., which are generically represented as a topic 82.

The method 100 is one embodiment in accordance with the present disclosure, other embodiments of the disclosure can be implemented. In one example, the computer system can be part of a service for providing the method disclosed herein as a service. The method 100 may be embodied in a program 22 embodied on a computer readable storage device, e.g., data storage device 24, and is executable by a processor 28 of the computer 20 (i.e., execute program steps, code, or program code). The program or executable instructions therefrom, may be offered as a service by a provider. The program may also be stored and run locally on a user device. The computer 20 and program 22 shown in FIG. 1 are generic representations of a computer and program that may be local to a user, or provided as a remote service, such as a website accessible using the Internet. It is understood that the computer 20 also generically represent herein a computer device such a personal data assistant, a laptop, or desktop computer, etc., or part of one or more servers, alone or as part of a datacenter. The computer system 20 can include a network interface 32, and input/output (I/O) interface(s) 34. The I/O interface 34 allows for input and output of data with an external device 36 that may be connected to the computing device. The network interface 32 may provide communications between the computing device and a computer network.

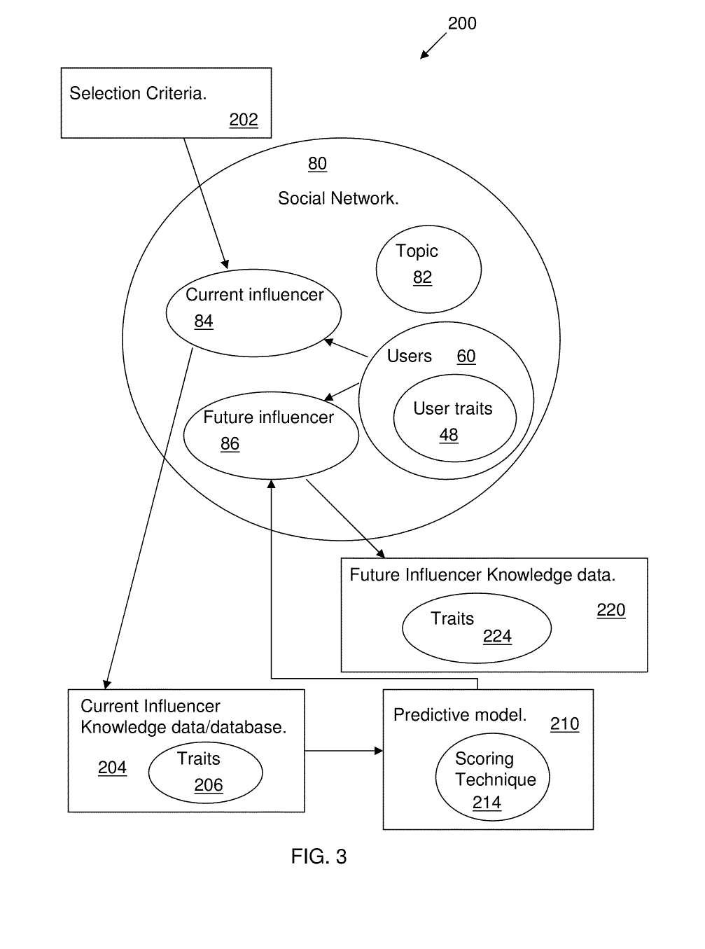

Referring to FIGS. 1-3, the method 100 is referred to using a functional depiction 200 and includes selecting a current influencer 84 (FIG. 3) from the plurality of users 60 based on a selection criteria 202 and generating a current influencer knowledge data 204 from the data 44 which can be stored in the database 40, as in step 108. The selection criteria 202 can include user personality traits 48 selected by subject matter experts. The influencer knowledge data 204 includes traits 206 of the current influencer 84.

The influencer knowledge data can include a present influencer who posts on a certain topic, or who is relevant to a specific campaign. A psychological profile analysis of current influencers can include analyzing social media posts of influencers who are in the knowledge database 204. From such analysis, a psycho-metric profile for each influencer can be constructed. In one embodiment, such a profile can include attributes derived from analysis of social media posts and using either a statistical correlation or predictive model. In another embodiment, a profile can include basic human value attributes, for example, which can be derived by using dictionary definitions and statistical correlations. In one embodiment, the dictionary can be generated by the method of the present disclosure.

A psychological based model for current influencers can include, in one embodiment, a machine learning based predictive model where influence scores of influencers in the knowledge base are used as ground truth to construct a predictive model. In one embodiment, influence scores are used to create a set of categories of influence scores (e.g., low, medium, high). A predictive model can include psycho-metric scores of influencers. In another embodiment, a set of rules may be created to map psycho-metric scores to influence scores/categories.

A psycho-metric based influence model can be applied to detect new influencers or future influencers. The model can analyze social media posts of a user to compute psycho-metric scores, and use the scores to derive an influence category from the model. The predicted/derived influence category can indicate how influential a given social media user is, based on the users psycho-metric properties. This allows detection of users as influential or future influencers, based on their psycho-metric similarity with current influential users.

In one example, current influencers can include personality traits or behavior including the following: influencers can show more neuroticism (emotional un-stability); influencers can be highly extroverted; influencers can be less agreeable; influencers can show more conservation (a basic human value attributes).

Personality assessment can be accomplished by analyzing social media posts and, for example, using a dictionary-based on a Big Five correlation approach. Big Five refers to personality traits and personality models which psychologists have developed. The Big Five personality model includes characterizing a person's traits from five aspects: openness, conscientiousness, extraversion, agreeableness, and neuroticism. The Big Five personality dimensions are five broad dimensions that can characterize a personality score. Together the Big Five personality dimensions can be used to identify the traits and structure of a personality. Each Big Five personality dimension is associated with lower level facets, which are specific and unique aspects of the broader personality dimension, as illustrated in Table 1 below.

TABLE 1

| Big Five | |
|---|---|
| Personality | |
| Dimensions | Lower Level Facets |
| Neuroticism | Anxiety, Anger, Depression, Self-consciousness, |
| | Immoderation, Vulnerability |
| Extraversion | Friendliness, Gregariousness, Assertiveness, |
| | Activity level, Excitement-seeking, Cheerfulness |
| Openness | Imagination, Artistic interests, Emotionality, |
| | Adventurousness, Intellect, Liberalism |
| Agreeableness | Trust, Morality, Altruism, Cooperation, Modesty, |
| | Sympathy |
| Conscientiousness | Self-efficacy, Orderliness, Dutifulness, Achievement- |
| | striving, Self-discipline, Cautiousness |

In another embodiment according to the disclosure, a dictionary of traits can be generated by the method of the disclosure.

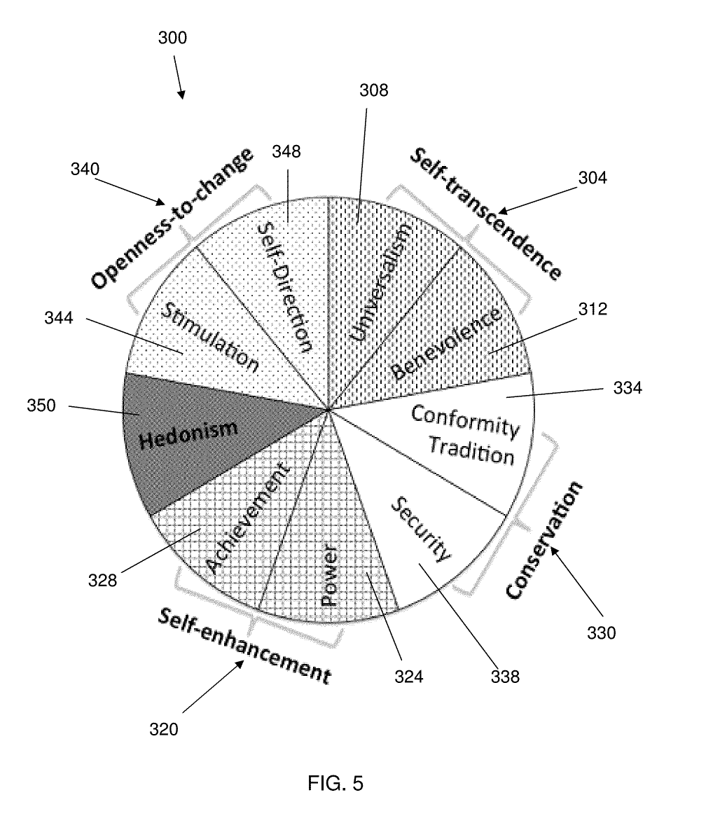

In analyzing a users personality or traits, basic human values have been proposed by social psychologists, which map onto higher-level value dimensions, as represented in Chart 300 (FIG. 5) (from An Overview of the Schwartz Theory of Basic Values, Shalom H. Schwartz, Dec. 1, 2012). The circumplex structure in Schwartz′ Value Theory shown in Chart 300 indicates relations of conflict and congruity across values. The closer any two values are to one another, the more similar their underlying motivations, and vice versa. Five value dimensions are discussed below.

Referring to the FIG. 5, self-transcendence 304 encompasses two basic human values involving concern for the welfare and interests of others: universalism 308, to pursue understanding, appreciation, tolerance and protection for the welfare of all people and for nature; and benevolence 312, to pursue the preservation and enhancement of the welfare of people with whom one is in frequent personal contact.

Self-enhancement 320 encompasses two basic human values related to the pursuit of self-interests: power 324, to pursue social status and prestige, control or dominance over people and resources; and achievement 328, to pursue personal success through demonstrating competence according to social standards.

Conservation 330 encompasses three basic human values related to self-restriction, order, and resistance to change: conformity and tradition 334, where conformity is to pursue restraint of actions, inclinations, and impulses likely to upset or harm others and violate social expectations or norms; and tradition, is to pursue respect, commitment, and acceptance of the customs and ideas that traditional culture or religion provide the self. Security 338, is to pursue safety, harmony, and stability of society, of relationships, and of self.

Openness-to-change 340 encompasses two basic human values related to the desire for independence and new experiences: stimulation 344, to pursue excitement, novelty and challenges in life; and self-direction 348, to attain independence in thought and action—to choose, create, and explore.

Hedonism 350 refers to the pursuit of pleasure and sensuous gratification for oneself. It is about seeking pleasure, enjoying life and self-indulgence. According to Schwartz, hedonism can be categorized under openness-to-change 75% of the time, but may also be related to self-enhancement. To keep the effects distinct, hedonism is kept as a separate value.

An exemplary psycholinguistic dictionary is shown in Chart 1 below. The method of the present disclosure can also create a psycholinguistic dictionary from user data and/or other sources. Both personality and value trait computation can use the psycholinguistic dictionary. The psycholinguistic dictionary matches words, for instance, matching words in a user's social media posts. From the dictionary, scores and statistical correlations between a dictionary category, and trait dimension, trait level scores can be computed.

CHART 1

| Dictionary Categories | Example Words |
|---|---|
| Positive Emotion | accept, active, admire |
| Positive Feelings | attachment, care, cheer |
| Communication | admit, affair apology |
| Inclusive | along, also, altogether |
| Perception | call, chat, contact, discuss |
| Anger | anger, angry |
| Anxious | afraid, alarm, anguish |
| Physical States | diabetes, disease, drink, dizzy |
| Social Process | interact, involve, kids, let's |
| Tentative | luck, may, nearly, perhaps |
| Time | start, stop, period, till, then |
| Present | keep, know, infer, like, listen |
| Other Refs | he, hers, she, their, them |

In an embodiment, for each person, a dictionary-based score in each category can be computed as the ratio of number of occurrences of words in that category in one's posts, and the total number of words in a user's posts. When computing a trait level score from such dictionary scores, a weighted linear combination of dictionary scores can be used, where a correlation coefficient between dictionary category and trait is used as weight.

A psycho-linguistic analysis can be generated on electronic communications by users. For example, the method 100 can utilize the psycholinguistic dictionary (Chart 1) for analysis when determining a current influence and a future influencer. A technique for analyzing user data can include proceeding word by word through user data, e.g., generated text from the users, and determining whether a word, phrase, and/or sentence included therein has a negative or positive correlation with a predetermined personality profile. Based on the technique for analyzing user data, a psycho-linguistic analysis can be generated.

An influencer knowledgebase or database can be developed, for example, by manual analysis by a subject matter expert, or using an influencer scoring/detection method which uses one or more observable behaviors, for example, network-strength, message-strength, reputation. A set of non-influencers who score low influence-scores can be included in the knowledge-base. A psycho-metric profile analysis can be conducted of the influencers, and non-influencers in the knowledge-base, where the profiles contain traits. The selection criteria can include using personality traits selected by subject matter experts. The data can include human behavioral data including personality traits. The selection criteria can include a psychological profile and personality traits both established by a subject matter expert.

A predictive model 210 is generated using the influencer knowledge data 204 in the database 40, as in step 112. The predictive model 210 can include a scoring method or technique 214 which includes comparing the traits of the current influencer with traits of the plurality of users gathered from the data 44.

Referring to FIGS. 1-3, according to the method 100, the data 44 is analyzed to predict a future influencer 86 (FIG. 3) of the plurality of users 60 using the predictive model 210. The scoring technique can be based on comparing (for similarity of traits 224 of a future influencer) the future influencer 86 to the traits 206 of the current influencer 84, as in step 118. Similarity of traits data can also be stored as part of the future influencer knowledge data 220. The traits 224 of the future influencer 86 can be gathered from the data 44 of the users 60 (including user traits 48) and compiled into the future influencer knowledge data 220. The method 100 selects from the plurality of users 60 a predicted future influencer using the analysis which includes the predictive model 210, as in step 122.

The scoring method/technique 214 can include the comparing of the traits of the current influencer with the traits of the plurality of users gathered from the data, to identify similar traits.

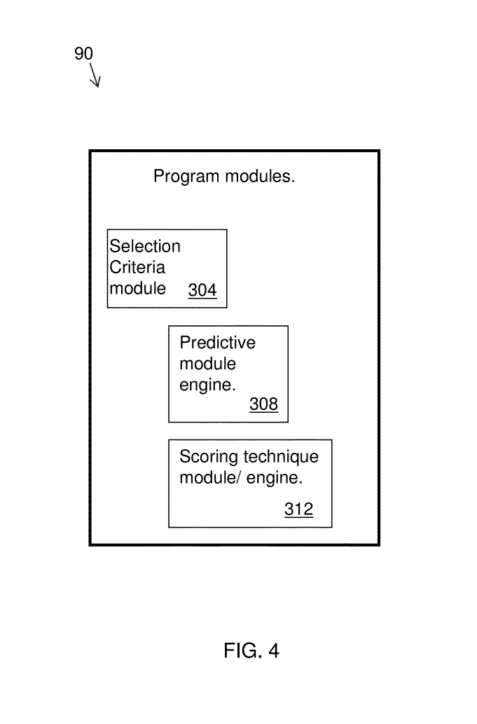

The method steps and system features may be embodied in modules of the program 22 for performing the tasks of each of the steps of the method and system, which are generically represented in FIG. 1 as program modules 90. The program 22 and program modules 90 can execute specific steps, routines, sub-routines, instructions or code, of the program. For example, referring to FIG. 4, a selection criteria module 304 can generate a selection criteria for selecting a current influencer, as in step 108 of the method 100 shown in FIG. 2. A predictive model engine module 308 can generate the predictive model 210 as described above, and as in step 12. A scoring technique engine module 31 can generate a scoring technique 214 as described above, and as in step 118.

Thereby, the present disclosure detects future influencers in a social group communicating via a social network. The identified future influencer can be contacted, for example, by targeted material, advertisement, products, or to join other social groups. Therefore, it is advantageous to detect influencers in an electronic social group in an early phase rather than after such a label has been established by analysis techniques of past activity.

The present disclosure includes an embodiment to detect influencers early by developing psychological profiles of users and determining and analyzing user traits, for example, including personality traits. The exemplary method of the disclosure generates a similarity analysis of such traits with influencers who are identified. Psychological profiles can include, for example, personality attributes/traits such as neuroticism, and basic human value attributes such as conservation. Similarity analysis can be done by either using rules developed by a subject matter expert (SME), or a machine learning based method or statistical based. Future influencers can also be categorized or ranked based on their psychological profiles and personality traits. The ranking of a plurality of future influencers can be in an order of probability of being an influencer according to a future influencer score. The scoring of a plurality of future influencers can predict which of the future influencers' will be the most influential.

In one embodiment of the disclosure, the method can be used in marketing and other messaging campaigns. For example, a marketer can extend reach of a marketing campaign by engaging with an early influencer. For other types of campaigns with other objectives (e.g., a campaign run by an agency), an early influencer can help grow the campaign. Early influencers can also be given incentives or persuaded to continue or grow in their influencer role. Additionally, a counter-campaign can be initiated to identify influencer to counter an existing campaign.

While embodiments of the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

Therefore, one or more Figures described herein may illustrate a schematic of an embodiment of the disclosure and may include a representative computer system or processing system that may implement a method and a program in one or more embodiments of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with one or more processing systems in the present disclosure may include, but are not limited to, personal computer systems, server computer systems, handheld or laptop devices, multiprocessor systems, microprocessor-based systems, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units, a system memory, and a bus that couples various system components including system memory to processor. Computer system may include a variety of computer system readable media. Such media may be any available media that is accessible by computer system, and it may include both volatile and non-volatile media, removable and non-removable media. System memory 58, shown in FIG. 1, can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices such as a keyboard, a pointing device, a display, etc.; one or more devices that enable a user to interact with computer system; and/or any devices (e.g., network card, modem, etc.) that enable computer system to communicate with one or more other computing devices. Such communication can occur via Input/Output (I/O) interfaces. Additionally, computer systems can communicate with one or more networks such as a local area network (LAN), a general wide area network (WAN), and/or a public network (e.g., the Internet) via network adapter. As depicted, network adapter communicates with the other components of computer system via bus. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

Additionally, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Further, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams as may be illustrated in the one or more Figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments, features, and instructive examples described above are illustrative, and should not be construed to limit the present disclosure to the particular embodiments or enumerated examples. Thus, various changes and modifications may be effected by one skilled in the art without departing from the spirit or scope of the disclosure as defined in the appended claims.

What is claimed is:

1. A method of early detection of social media influencers which use a communications system, comprising:
selecting a current influencer from a plurality of users communicating on a social network, the current influencer being based on a selection criteria;
generating a database from data of each of the users, the database including traits of the current influencer;
generating a predictive model using the database, the predictive model including a scoring method which includes comparing the traits of the current influencer with traits of the plurality of users gathered from the data;
analyzing the data to predict a future influencer of the plurality of users using the predictive model; and
selecting a predicted future influencer from the plurality of users, using the analysis.

2. The method of claim 1, wherein the scoring method includes the comparing of the traits of the current influencer with the traits of the plurality of users gathered from the data, to identify similar traits.

3. The method of claim 1, wherein the database includes a psychological profile, which includes personality traits.

4. The method of claim 1, further comprising:
ranking a plurality of future influencers in an order of probability according to a future influencer score.

5. The method of claim 1, further comprising:
scoring a plurality of future influencers to predict which of the future influencers' will be the most influential.

6. The method of claim 1, wherein the predictive model includes non-influencer traits.

7. The method of claim 1, wherein the predictive model is either statistical based or rule based.

8. The method of claim 1, wherein the selection criteria includes using personality traits selected by subject matter experts.

9. The method of claim 1, wherein the data includes human behavioral data including personality traits.

10. The method of claim 1, wherein the selection criteria includes a psychological profile and personality traits both established by a subject matter expert.

11. A computer program product comprising a computer readable storage medium having program code embodied therewith, the program code being executable by a processor to:
selecting a current influencer from a plurality of users communicating on a social network, the current influencer being based on a selection criteria;
generating a database from data of each of the users, the database including traits of the current influencer;
generating a predictive model using the database, the predictive model including a scoring method which includes comparing the traits of the current influencer with traits of the plurality of users gathered from the data;
analyzing the data to predict a future influencer of the plurality of users using the predictive model; and
selecting a predicted future influencer from the plurality of users, using the analysis.

12. The computer program product of claim 1, wherein the scoring method includes the comparing of the traits of the current influencer with the traits of the plurality of users gathered from the data, to identify similar traits.

13. The computer program product of claim 11, further comprising:
ranking a plurality of future influencers in an order of probability according to a future influencer score.

14. The computer program product of claim 11, further comprising:
scoring a plurality of future influencers to predict which of the future influencers' will be the most influential.

15. The computer program product of claim 11, wherein the predictive model includes non-influencer traits.

16. The computer program product of claim 11, wherein the predictive model is either statistical based or rule based.

17. A system comprising:
a memory having computer readable computer instructions; and
a processor for executing the computer readable instructions, the instruction including:
selecting a current influencer from a plurality of users communicating on a social network, the current influencer being based on a selection criteria;
generating a database from data of each of the users, the database including traits of the current influencer;
generating a predictive model using the database, the predictive model including a scoring method which includes comparing the traits of the current influencer with traits of the plurality of users gathered from the data;
analyzing the data to predict a future influencer of the plurality of users using the predictive model; and
selecting a predicted future influencer from the plurality of users, using the analysis.

18. The system of claim 1, wherein the scoring method includes the comparing of the traits of the current influencer with the traits of the plurality of users gathered from the data, to identify similar traits.

19. The system of claim 17, wherein the database includes a psychological profile, which includes personality traits.

20. The system of claim 17, wherein the predictive model is either statistical based or rule based.
